(19) United States
(12) Patent Application Publication
(10) Pub. No.: US 2013/0078389 A1
(43) Pub. Date: Mar. 28, 2013

(54) PATTERN FORMATION METHOD

(71) Applicants: Kei NARA, Yokohama-shi (JP); Masakazu Hori, Yamato-shi (JP); Hirofumi Shiono, Fujisawa-shi (JP); Takashi Sugizaki, Yokohama-shi (JP)

(72) Inventors: Kei NARA, Yokohama-shi (JP); Masakazu Hori, Yamato-shi (JP); Hirofumi Shiono, Fujisawa-shi (JP); Takashi Sugizaki, Yokohama-shi (JP)

(21) Appl. No.: 13/591,350

(22) Filed: Aug. 22, 2012

Related U.S. Application Data
(63) Continuation of application No. PCT/JP2011/053106, filed on Feb. 15, 2011.

(30) Foreign Application Priority Data
Feb. 26, 2010 (JP) P2010-043022

(51) Int. Cl. B05D 5/00

(52) U.S. Cl. CPC B05D 5/00
USPC 427/553

(57) ABSTRACT

The present invention aims to provide a pattern formation method capable of shortening processing time by accelerating a decomposition reaction of a silane coupling agent. The present invention comprises a step for arranging a silane coupling agent (2) on a substrate (1) and having a photocatalyst (3) present for the silane coupling agent (2), and a step for irradiating the silane coupling agent (2) and the photocatalyst (3) with light L containing light having absorption wavelengths of the silane coupling agent (2) and the photocatalyst (3).

### BACKGROUND OF THE INVENTION

1. Field of the Invention

The present invention relates to a pattern formation method.

2. Description of the Related Art

Etching carried out through a mask pattern formed by photolithography has been conventionally used as a technology for forming circuit patterns and various types of material patterns provided in transistors and the like. For example, in the case of forming circuit pattern of an electrically conductive material on a substrate, a material layer is first formed over the substrate surface by vapor deposition of the electrically conductive material, then a mask pattern is formed by applying a photoresist to the material layer followed by exposure and development (photolithography). Subsequently, unnecessary portions other than the circuit pattern are removed by etching through the formed mask, and the target circuit pattern is then formed by removing the mask pattern.

However, in this method, there is considerable waste since forming materials other than the portion that remains as the circuit pattern are discarded. In addition, since an alkaline developing solution is typically used for development and a strongly acidic etching solution is typically used in the etching step, there is a considerable burden on the environment resulting from the generation of large amounts of alkaline and strongly acidic waste liquids. Thus, numerous studies have been conducted on pattern formation methods that differ from the conventional method described above.

For example, in Patent Documents 1 and 2 and Non-Patent Document 1, studies were conducted for forming a desired material pattern while preventing waste of pattern forming materials by modifying the surface status of a substrate surface on which a material pattern is to be formed according to the material pattern to be formed, and then selectively arranging forming materials of the material pattern corresponding to surface status.

For example, Patent Document 1 proposes a method for forming a target material pattern corresponding to a lyophilic-lyophobic pattern by forming the lyophilic-lyophobic pattern using a silane coupling agent that is decomposed upon irradiation with light thereby forming lyophilicity-lyophobicity pattern according to whether or not the saline coupling agent is decomposed.

In addition, Patent Document 2 proposes a method for forming a target material pattern using a silane coupling agent that is decomposed upon irradiation with light thereby generating a functional group, and bonding a substituent to the resulting functional group that generates lyophilicity-lyophobicity that differs from that of the silane coupling agent prior to irradiating with light.

Moreover, Non-Patent Document 1 proposes a method for forming a target material pattern by forming a thin film on a surface to be formed using a silane coupling agent that demonstrates lyophobicity, followed by contacting with a photocatalyst and selectively irradiating with ultraviolet light to decompose and remove the silane coupling agent contacted by the photocatalyst irradiated with ultraviolet light and form a lyophilic-lyophobic pattern.

In these methods, formation of a material pattern is realized while preventing waste of pattern forming materials by finely controlling lyophilicity-lyophobicity of the surface to be formed using a silane coupling agent and selectively applying a solution of the pattern forming material to a location where lyophilicity is demonstrated. In addition, since formation of the lyophilic-lyophobic pattern is the result of decomposing a substance on a substrate surface, that is generated upon irradiation with light, there is no generation of large amounts of strongly acidic or alkaline waste liquid, thereby lowering the burden on the environment.

### PRIOR ART DOCUMENTS

### Patent Documents

Patent Document 1: Japanese Unexamined Patent Application, First Publication No. 2008-50321
Patent Document 2: Japanese Unexamined Patent Application, First Publication No. 2008-171978

### Non-Patent Documents

Nakata, K. and Fujishima, A.: Development and Application of a Fine Patterning Technology using a Photocatalyst, Optical and Electro-Optical Engineering Contact, 2009, Vol. 47, No. 8, pp. 12-19

### SUMMARY OF THE INVENTION

### Problems to be Solved by the Invention

However, in the case of a decomposition reaction by irradiating with light (and partially including a substituent elimination reaction) or a decomposition reaction using a photocatalyst as in the prior art, the reaction rates are slow in both cases, and it is necessary to radiate high-energy light from an extremely high-output light source in order to obtain a practical reaction.

With the foregoing in view, an object of the present invention is to provide a pattern formation method capable of shortening processing time.

### Means for Solving the Problems

In order to solve the aforementioned problems, the pattern formation method of one aspect of the present invention is a pattern formation method for forming a desired pattern on surface to be treated of a target, comprising: a step for arranging a silane coupling agent represented by general formula (1) on the surface to be treated and having a photocatalyst present for the silane coupling agent on the surface to be treated, and a step for irradiating the silane coupling agent and the photocatalyst with light containing light having absorption wavelengths of the silane coupling agent and the photocatalyst:

[Chemical Formula 1]

R¹—R²—SiX¹X²X³ (1)

(wherein, R¹ represents a photoreactive protecting group that is eliminated by irradiating with light, R² represents an organic group that generates a functional group that has lyophilicity-lyophobicity differing from that of R¹ as a result of elimination of R¹, X¹ represents an alkoxy group or halogen atom, X² and X³ represent a hydrogen atom, alkyl group or alkenyl group, and X¹, X² and X³ may be the same or different).

In this aspect of the present invention, R¹ in general formula (1) preferably has a fluorine-substituted alkyl group.

In this aspect of the present invention, the method preferably comprises a step for modifying a functional group generated on R² in general formula (1) by eliminating R¹ in general formula (1) with a functional group having lyophilicity-lyophobicity differing from that of R¹, after the step for irradiating with light.

In this aspect of the present invention, the step for having a photocatalyst present for the silane coupling agent can be selected from the following two methods. First, the step for having a photocatalyst present for the silane coupling agent preferably has a step for arranging the silane coupling agent on the target and a step for applying a dispersion of the photocatalyst to the silane coupling agent.

Alternatively, in this aspect of the present invention, the step for having a photocatalyst present for the silane coupling agent preferably has a step for forming a photocatalyst layer having the photocatalyst as a forming material thereof on the target, and a step for arranging the silane coupling agent on the photocatalyst layer.

In this aspect of the present invention, the silane coupling agent is preferably arranged by application of the silane coupling agent.

In this aspect of the present invention, the absorption wavelengths of the silane coupling agent and the photocatalyst are preferably in the same wavelength band.

In this aspect of the present invention, the method preferably comprises a step for applying a solution or dispersion of a pattern forming material to a region where lyophilicity is demonstrated to a relatively greater degree in the pattern, after the step for irradiating with light.

### EFFECTS OF THE INVENTION

According to the pattern formation method of an aspect of the present invention, the combined use of a photocatalyst makes it possible to shorten processing time by accelerating an elimination reaction of a photoreactive protecting group.

### BRIEF DESCRIPTION OF THE DRAWINGS

FIG. 1 is an explanatory drawing for explaining a first embodiment of the present invention.

FIG. 2 is an explanatory drawing for explaining a second embodiment of the present invention.

FIG. 3 is a drawing showing results for an example of the present invention.

FIG. 4 is a drawing showing results for an example of the present invention.

FIG. 5 is a drawing showing results for an example of the present invention.

FIG. 6 is a drawing showing results for an example of the present invention.

### DETAILED DESCRIPTION OF THE PREFERRED EMBODIMENTS

### First Embodiment

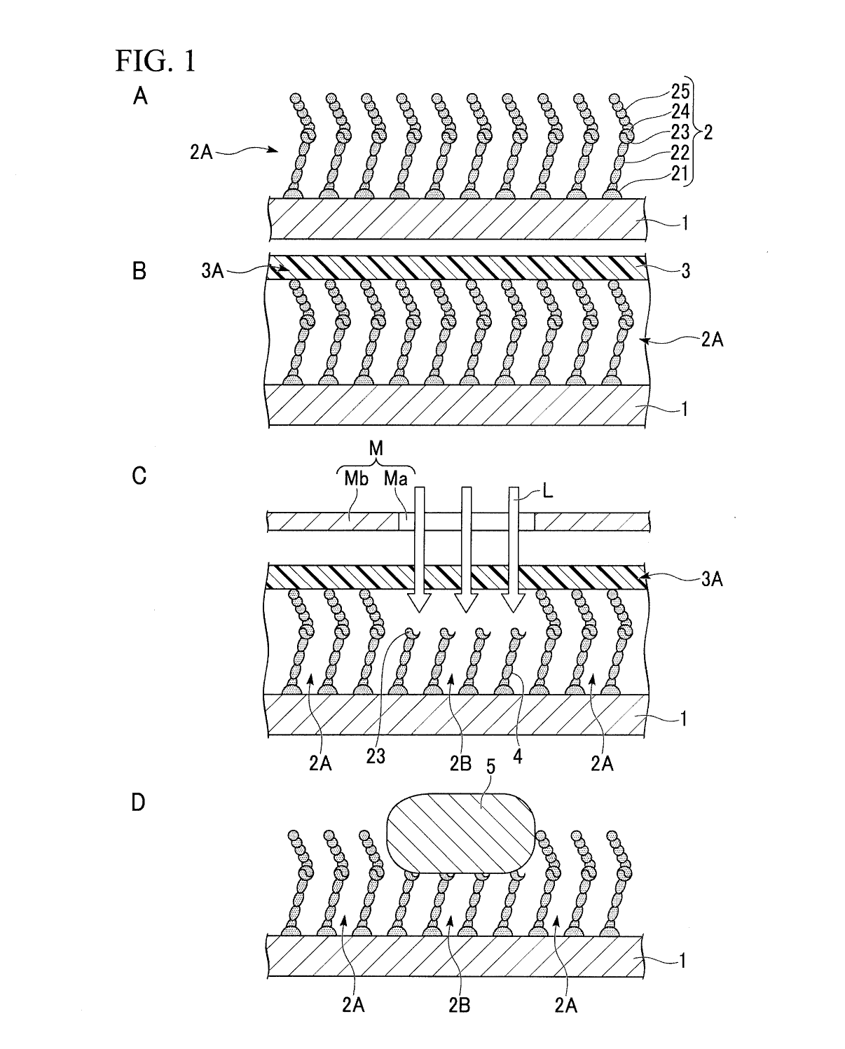

FIG. 1 is an explanatory drawing for explaining a pattern formation method according to a first embodiment. Furthermore, in all of the following drawings, dimensions, ratios and so forth of each constituent have been suitably altered to facilitate drawing legibility.

In the pattern formation method of the present embodiment, a lyophilic-lyophobic pattern is formed at a region having different lyophilicity-lyophobicity (a region having different surface energy) by modifying the surface of a target (substrate 1). Irradiation with light is used to form the lyophilic-lyophobic pattern, and the region irradiated with light is a lyophilic region. Moreover, a solution or dispersion of a forming material of a material pattern is applied to a highly lyophilic region formed in the aforementioned lyophilic-lyophobic pattern formation method, and a material pattern is formed that corresponds to the lyophilic-lyophobic pattern. The following provides an explanation of the method in the order thereof.

(Lyophilic-Lyophobic Pattern Formation)

First, as shown in FIG. 1A, a silane coupling agent 2 having a photoreactive protecting group is applied to the surface of the substrate 1 where a pattern is to be formed (surface to be treated) to form a thin film 2A of the silane coupling agent 2. In the case of forming the thin film 2A by applying the silane coupling agent 2, in comparison with the case of forming the thin film 2A using a gas phase reaction, special equipment such as vacuum equipment or a chamber are not required, and the silane coupling agent can be easily arranged.

A forming material such as PET, PMMA or other plastic, metal or glass can be selected as necessary for the substrate 1. In the case of using plastic for the forming material, an SiO₂ layer may also be formed on the surface as a barrier layer. The substrate surface where the lyophilic-lyophobic pattern is to be formed preferably has a large number of hydroxyl (—OH) groups, and as necessary, the surface where the lyophilic-lyophobic pattern is to be formed can be treated to remove impurities on the substrate surface and increase the number of hydroxyl groups by washing using oxygen plasma treatment or chemical treatment before applying the silane coupling agent.

The silane coupling agent 2 able to be used in the present invention can be represented by the following general formula (2)

[Chemical Formula 2]

R¹—R²—SiX¹X²X³ (2)

(wherein, R¹ represents a photoreactive protecting group that is eliminated by irradiating with light, R² represents an organic group that generates a functional group that has lyophilicity-lyophobicity differing from that of R¹ as a result of elimination of R¹, X¹ represents an alkoxy group or halogen atom, X² and X³ represent a functional group selected from a hydrogen atom, alkyl group, alkenyl group, alkoxy group and halogen atom, and X¹, X² and X³ may be the same or different).

Examples of photoreactive protecting groups represented by R¹ in formula (2) include a substituent having a 2-nitrobenzyl derivative backbone, a dimethoxybenzoin group, 2-nitropiperonyloxycarbonyl (NPOC) group, 2-nitroveratryloxycarbonyl (NVOC) group, α-methyl-2-nitropiperonyloxycarbonyl (MeNPOC) group, α-methyl-2-nitroveratryloxycarbonyl group (MeNVOC) group, 2,6-dinitrobenzyloxycarbonyl (DNBOC) group, α-methyl-2,6-dinitrobenzyloxycarbonyl (MeDNBOC) group, 1-(2-nitrophenyl)ethyloxycarbonyl (NPEOC) group, 1-methyl-1-(2-nitrophenyl)ethyloxycarbonyl (MeNPEOC) group, 9-anthracenylmethyloxycarbonyl (ANMOC) group, 1-pyrenylmethyloxycarbonyl (PYMOC) group, 31-methoxybenzoinyloxycarbonyl (MBOC) group, 3′,5′-dimethoxybenzoyloxycarbonyl (DMBOC) group, 7-nitroindolinyloxycarbonyl (NIOC) group, 5,7-dinitroindolinyloxycarbonyl (DNIOC) group, 2-anthraquinonylmethyloxycarbonyl (AQMOC) group, α,α-dimethyl-3,5-dimethoxybenzyloxycarbonyl group, 5-bromo-7-nitroindolinyloxycarbonyl (BNIOC) group, 2,2-dimethyl-1,3-dioxine group and 2-nitrobenzylcarbamoyl group.

In addition, protecting groups represented by the following formulas (3) to (6) can also be used.

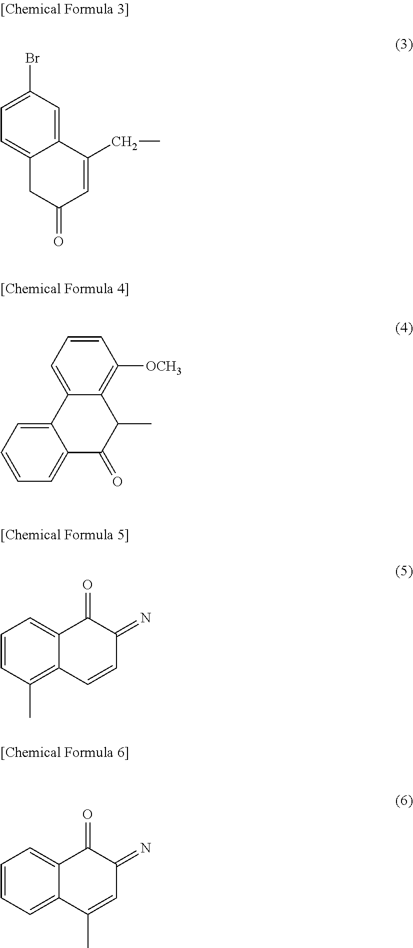 [SMILES: CCC1=CC(=O)Cc2ccc(Br)cc21 ; COc1cccc2c1C(C)C(=O)c1ccccc1-2 ; Cc1cccc2c1C=CC(=N)C2=O ; CC1=CC(=N)C(=O)c2ccccc21]

Among these, a substituent having a 2-nitrobenzyl derivative backbone is preferable. Moreover, a portion of R¹ may be substituted with a fluoroalkyl group or linear alkyl group having 8 or more carbon atoms, and may demonstrate high lyophobicity.

The organic group represented by R² in formula (2) includes a functional group that bonds with R¹ and has lyophilicity-lyophobicity that differs from that of R¹, and a divalent linking group that links the functional group with a silicon atom. Examples of functional groups having lyophilicity-lyophobicity differing from that of R¹ include an amino group, hydroxyl group, carboxyl group, sulfo group and phosphate group, while examples of linking groups include an alkylene group, cycloalkylene group, alkene-1,2-diyl group, alkyne-1,2-diyl group and arylene group. The linking group preferably has 1 to 22 carbon atoms. A portion of the side chains of these linking groups may be substituted with an alkyl group, alkenyl group, alkynyl group, aryl group, alkylsilyl group or halogen atom.

Examples of alkoxy groups represented by X¹, X² and X³ in formula (2) include a methoxy group, ethoxy group, n-propoxy group, isopropoxy group, n-butoxy group, isobutoxy group, sec-butoxy group and tert-butoxy group. From the viewpoint of facilitating removal by making the molecular weight of the leaving alcohol comparatively low, the number of carbons of the alkoxy group is preferably within the range of 1 to 4.

These silane coupling agents can be suitably synthesized using commonly known synthesis methods.

In FIG. 1A schematically shows a representation using a diagram in which the silicon (Si) portion bonded to the substrate surface is represented by reference symbol 21, the linking group of the organic group represented by R² is represented by reference symbol 22, the hydrophilic functional group bonded to the photoreactive protecting group represented by R¹ is represented by reference symbol 23, R¹ is represented by reference symbol 24, and the fluoroalkyl group of R¹ is represented by reference symbol 25.

As a result of applying this silane coupling agent 2 onto the substrate 1 by ejecting a suitable amount thereof from a slit-like nozzle, the hydroxyl groups on the surface of the substrate react with the alkoxy group or halogen atom of the silane coupling agent to form the thin film 2A. The surface of the formed thin film 2A undergoes a decrease in surface energy corresponding to the physical properties of the silane coupling agent, and demonstrates higher lyophobicity than the surface of the substrate 1.

Next, as shown in FIG. 1B, a film 3A of a photocatalyst 3 is formed on the thin film 2A of the silane coupling agent to contact the photocatalyst 3 with the silane coupling agent 2.

Any photocatalyst can be used for the photocatalyst 3 provided it has a photocatalytic effect. Examples include metal oxide semiconductors such as titanium dioxide (TiO₂), zinc oxide (ZnO), tin oxide (SnO₂), tungsten oxide (WO₃), bismuth oxide (Bi₂O₃), iron oxide (Fe₂O₃), cadmium oxide (CdO), indium oxide (In₂O₃), silver oxide (Ag₂O), manganese oxide (MnO₂), copper oxide (Cu₂O), vanadium oxide (V₂O₅), niobium oxide (Nb₂O₃), or strontium titanate (SrTiO₃), and metal sulfide semiconductors such as cadmium sulfide (CdS), zinc sulfide (ZnS), indium sulfide (In₂S₃), lead sulfide (PbS), copper sulfide (Cu₂S), molybdenum sulfide (MoS₂), tungsten sulfide (WS₂), antimony sulfide (Sb₂S₃) or bismuth sulfide (Bi₂S₃).

In addition, a mixture of fine particles obtained by mixing different types of photocatalytic particles can also be used. Examples include CdS/TiO₂, CdS/silver iodide (AgI), CdS/ZnO, CdS/PbS, CdS/mercury sulfide (HgS), ZnO/ZnS and ZnO/zinc selenide (Zn/Se).

Among these, titanium dioxide is preferable from the viewpoints of stability, economy or handling ease. Titanium dioxide having an anatase crystal structure is preferably used for the titanium oxide since it has a small band gap and easily demonstrates catalytic action when irradiated with light as is commonly known. In addition, fine particles of titanium dioxide on the nanometer order are used preferably for the purpose of increasing the surface area of the titanium dioxide and enhancing reaction efficiency.

A coated film of the photocatalyst 3 is formed by applying a dispersion of this photocatalyst dispersed in a dispersion medium such as water, alcohol or saturated hydrocarbon onto the thin film 2A of the silane coupling agent. Examples of the application methods that can be used include printing methods such as spin coating, screen printing or inkjet printing.

Next, as shown in FIG. 1C, light L is radiated at the location where a lyophilic region is to be formed through an aperture Ma of a mask M.

The light L is light of a bandwidth that contains an absorption wavelength for deprotecting the photoreactive protecting group of the silane coupling agent 2 used and an absorption wavelength for generating photocatalytic activity by the photocatalyst 3. For example, in the case of using a substituent having a 2-nitrobenzyl derivative backbone for the photoreactive protecting group and using titanium dioxide for the photocatalyst 3, ultraviolet light is radiated for the light L using a light source capable of radiating at least the i-line (365 nm). An ordinary high-pressure mercury lamp, for example, is applicable for this type of light source.

In this manner, in the case the absorption wavelength of the silane coupling agent (or the photoreactive protecting group) and the absorption wavelength of the photocatalyst are in the same wavelength band, by radiating light of the same wavelength band, deprotection of the photoreactive protecting group can be easily accelerated, thereby making this preferable. In the case the absorption wavelengths of the photoreactive protecting group and the photocatalyst are different, two light sources that emit light corresponding to each absorption wavelength are used and light is radiated simultaneously.

When the light L is radiated, the photoreactive protecting group leaves and a thin film 2B composed of a silane coupling agent 4 having a hydrophilic functional group on the end thereof (on the side of the surface of the thin film) is formed at the thin film 2A at a location where it overlaps with the aperture Ma. The surface of the thin film 2B demonstrates high lyophilicity attributable to the functional group 23 on the end of the silane coupling agent 4.

In addition, since the light L is radiated not only onto the silane coupling agent 2 but also onto the photocatalyst 3 in contact with the silane coupling agent 2, the photocatalyst 3 enters a photoexcited activated state. Whereupon, excitation energy of the photocatalyst 3 is transferred to the silane coupling agent 2 in contact therewith, and the elimination reaction of the photoreactive protective group is accelerated. Moreover, a portion of the silane coupling agent 2 undergoes decomposition attributable to the high oxidizing strength of the photocatalyst 3.

As a result of these reactions occurring together, lyophobicity due to the silane coupling agent 2 decreases in the region irradiated with light. On the other hand, since the protecting group elimination reaction does not occur in the region covered by the blocking portion Mb of the mask M that is not irradiated with the light L, a high level of lyophilicity is maintained. Consequently, a lyophilic-lyophobic pattern can be favorably formed based on whether or not the pattern has been irradiated with light.

In the present embodiment, high lyophobicity is provided as a result of the photoreactive protecting group in the form of R¹ having a fluoroalkyl group. Consequently, in comparison with the case of R¹ not having a fluoroalkyl group, the contrast in lyophilicity-lyophobicity with the functional group generated after R¹ has left is increased, and a well-defined lyophilic-lyophobic pattern can be formed. Lyophilicity-lyophobicity can be evaluated according to liquid contact angle.

After irradiating with light, the surfaces of the thin films 2A and 2B are washed to rinse off the photocatalyst. Since a photocatalytic reaction does not occur even if the target on which the pattern has been formed is further irradiated with light, deterioration of the target caused by an unnecessary photocatalytic reaction can be inhibited. As a result of washing the surfaces, the coated photocatalyst 3 and residue of the leaving photoreactive protecting group are removed, thereby completing formation of the desired lyophilic-lyophobic pattern on the substrate I.

(Material Pattern Formation)

Next, as shown in FIG. 1D, a solution or dispersion of a forming material of a material pattern is applied to the highly lyophilic thin film 2B using a printing method followed by drying and selectively arranging a pattern forming material 5 to form a material pattern. Heat treatment may also be carried out as necessary after drying.

The use of an electrically conductive material for the forming material enables the formation of a wiring pattern or circuit pattern. An organic electrically conductive material or metal fine particles such as those of copper or silver can be used for the electrically conductive material, and a solution or dispersion of the forming material of the material pattern can be prepared by dissolving these forming materials in a suitable solvent or dispersing in a dispersion medium.

Even if these solutions or dispersions are arranged at a region that protrudes from the thin film 2B and overlaps with the thin film 2A, since the solutions or dispersions are repelled by the lyophobicity of the thin film 2A, they can be easily removed by washing the surface after drying.

In this manner, a desired material pattern can be formed using the material pattern formation method of the present embodiment.

According to the lyophilic-lyophobic pattern formation method as described above, the combined use of a photocatalyst makes it possible to accelerate the elimination reaction of the photoreactive protecting group and shorten processing time. In addition, a material pattern can be formed in a short period of time while inhibiting waste of pattern materials (such as electrically conductive materials) and without generating large amounts of strongly acidic or alkaline waste liquids.

Furthermore, although the silane coupling agent is arranged on the substrate 1 by applying the silane coupling agent in the present embodiment, the method used to arrange the silane coupling agent is not limited thereto. For example, the silane coupling agent can also be adhered to the surface of a substrate placed in depressurized environment using a gas phase reaction by evaporating the silane coupling agent in the depressurized environment.

### Second Embodiment

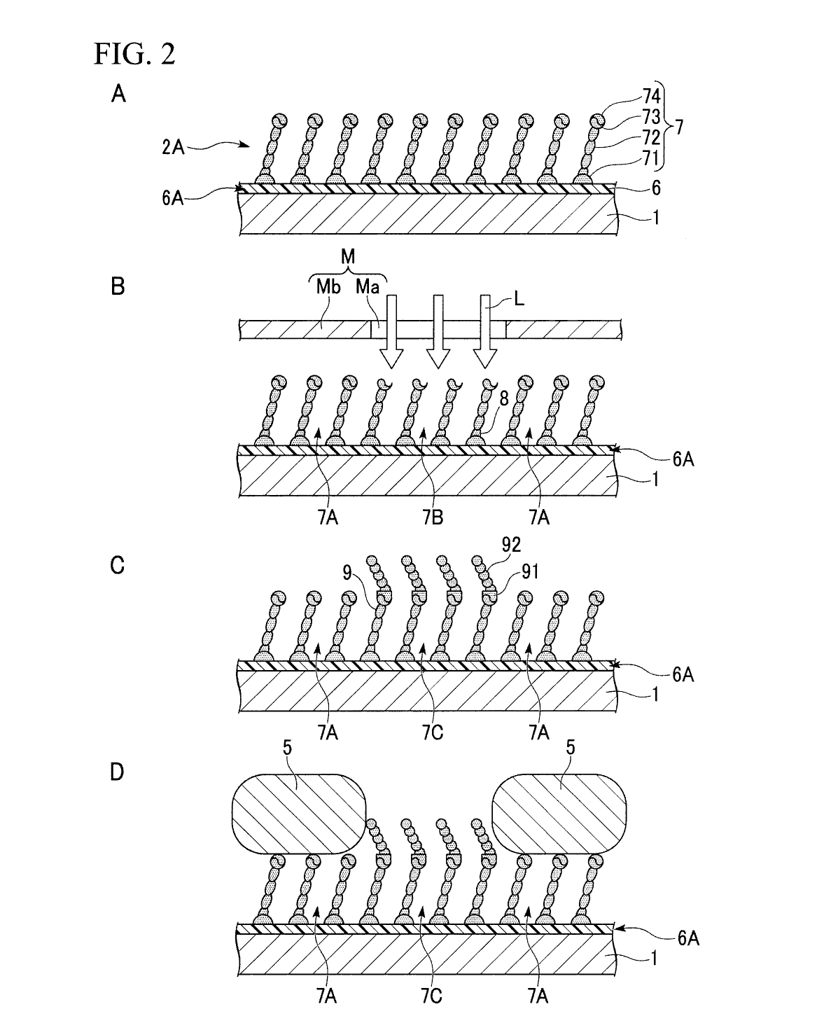

FIG. 2 is an explanatory drawing of a pattern formation method according to a second embodiment of the present invention. The present embodiment is in common with a portion of the first embodiment, and differs with respect to making the region where light is irradiated to be lyophobic. Thus, the same reference symbols are used to indicate those elements of the present embodiment that are in common with those of the first embodiment, and detailed descriptions thereof are omitted.

(Lyophilic-Lyophobic Pattern Formation)

First, as shown in FIG. 2A, a photocatalyst 6 is applied to the surface of the substrate 1 where a lyophilic-lyophobic pattern is to be formed to form a photocatalytic layer 6A. The same photocatalysts indicated in the first embodiment can be used for the photocatalyst. A silane coupling agent 7 having a photoreactive protecting group is then applied to the photocatalytic layer 6A to form a thin film 7A of the silane coupling agent 7 and contact the silane coupling agent 7 with the photocatalyst 6. The photocatalyst and the silane coupling agent can be reliably contacted by forming the thin film 7A of the silane coupling agent 7 on the photocatalyst 6 formed on the photocatalyst layer 6A.

The same silane coupling agents indicated in the first embodiment can be used for the silane coupling agent 7. A silane coupling agent in which a portion of R indicated in general formula (2) is not substituted with a fluoroalkyl group or linear alkyl group having 8 carbons or more can be used for the silane coupling agent used here.

In FIG. 2, the silicon (Si) portion bonded to the substrate surface is represented by reference symbol 71, the linking group of the organic group represented by R² is represented by reference symbol 72, the hydrophilic functional group bonded to the photoreactive protecting group represented by R¹ is represented by reference symbol 73 and R¹ is represented by reference symbol 74.

Next, as shown in FIG. 2B, the light L is selectively radiated at the location where a lyophobic region is to be formed through the aperture Ma of the mask M. When the light L is radiated, the photoreactive protecting group leaves and a thin film 7B composed of a silane coupling agent 8 having a hydrophilic functional group on the end thereof (on the side of the surface of the thin film) is formed at the thin film 7A at a location where it overlaps with the aperture Ma. Following radiation of light, residue of the leaving photoreactive protecting group may be removed by washing the surfaces of the thin films 7A and 7B.

Next, as shown in FIG. 2C, the functional group of the silane coupling agent 8 is reacted with a reagent provided with a substituent that demonstrates higher lyophobicity than the leaving photoreactive protecting group to form a silane coupling agent 9 in which this substituent is introduced onto the end of the silane coupling agent and obtain a thin film 7C.

Examples of a substituent that demonstrates higher lyophobicity than the photoreactive protecting group include a fluoroalkyl group and a linear alkyl group having 8 or more carbon atoms, and there are no limitations thereon provided it demonstrates higher lyophobicity than the photoreactive protecting group R¹. Any reagent can be used for this reagent for introducing such a substituent onto the end of a silane coupling agent provided it has a functional group capable of reacting with the functional group of the silane coupling agent 8 (reference symbol 73) and demonstrates high lyophobicity as previously described.

Typically, a reagent is selected that has a substituent that generates an ester bond with the functional group of the silane coupling agent 8. For example, in the case the functional group of the silane coupling agent 8 is a carboxyl group, the silane coupling agent 9 is obtained by reacting an amine having a fluoroalkyl group. In FIG. 2C, the functional group that bonds with the silane coupling agent 8 is indicated with reference symbol 91, while the introduced substituent that demonstrates high lyophobicity is indicated with reference symbol 92.

Even if this type of reagent is arranged at a region that protrudes from the thin film 73 and overlaps with the thin film 7A, since the functional group capable of reacting with the reagent is protected by the photoreactive protecting group on the surface of the thin film 7A, bonding does not occur and the reagent can be removed by washing the surface after the reaction.

As a result, a lyophilic-lyophobic pattern can be formed such that high lyophobicity is demonstrated by the newly introduced substituent in the region irradiated with light, and relatively low lyophobicity (high lyophilicity) as compared with the newly introduced substituent is demonstrated in the region not irradiated with light. In addition, the lyophilicity-lyophobicity of the region irradiated with light can be designed as desired resulting in a high degree of design freedom according to the lyophilicity-lyophobicity of the newly introduced substituent.

(Material Pattern Formation)

Next, as shown in FIG. 2D, a solution or dispersion of a forming material of a material pattern is applied to the relatively highly lyophilic thin film 7A using a printing method followed by drying and selectively arranging a pattern forming material 5 to form a material pattern. Heat treatment may also be carried out as necessary after drying.

In this manner, a desired material pattern can be formed using the material pattern formation method of the present embodiment.

In the case of the aforementioned pattern formation method as well, the combined use of a photocatalyst makes it possible to accelerate the elimination reaction of the photoreactive protecting group and shorten processing time.

Furthermore, although a substituent that demonstrates lyophobicity such as a fluoroalkyl group or linear alkyl group is not present on the photoreactive protecting group in the present embodiment, the present invention is not limited thereto, but rather a target lyophilic-lyophobic pattern can be formed and a material pattern can be formed by using that lyophilic-lyophobic pattern provided the newly introduced substituent generates relatively higher lyophobicity.

In addition, although the region irradiated with light was made to be a lyophobic region by introducing a substituent realizing high lyophobicity on the end of a silane coupling agent in the present embodiment, the present invention is not limited thereto, but rather the region irradiated with light may also be made to be relatively lyophilic by selecting a substituent that realizes high lyophilicity for the introduced substituent.

Although the above has provided an explanation of preferred embodiments according to the present invention while referring to the attached drawings, it goes without saying that the present invention is not limited to these embodiments. The various forms and combinations of each constituent member indicated in the aforementioned embodiments are merely intended to be examples, and can be altered in various ways based on design requirements and the like within a range that does not deviate from the gist of the present invention.

For example, the use of a thinly formed substrate makes it possible for the substrate 1 to be a flexible substrate, and in the case of using such a flexible substrate, the aforementioned pattern formation method can be realized by so-called roll-to-roll processing. In this case, all or a portion of each of the aforementioned processes of applying silane coupling agents, applying photocatalysts, irradiating with light through a mask and applying a forming material of a material pattern can be carried out within the steps of roll-to-roll processing. In the case of roll-to-roll processing, these processes may be carried out while moving the flexible substrate or after stopping the flexible substrate.

### EXAMPLES

Although the following provides a detailed explanation of the present invention through examples and comparative examples thereof, the present invention is not limited by these examples.

[Sample Preparation]

In the examples, the samples indicated in the following Examples 1 and 2 and Comparative Example 1 were prepared using a compound A represented in formula (7) indicated below (3-0-{3′-[N—(N′-maleimido)methylcarbonyl-N-carboxymethylamino]-3-aza-2-propenyl}-6-0-(2-nitrobenzyl)fluorescein, Dojindo Laboratories), each of the samples was irradiated with light, and an elimination reaction of the photoreactive protecting group was confirmed to accelerated by a photocatalyst.

Compound A is a caged fluorescent dye compound having a photoreactive protecting group in the form of a 2-nitrobenzyl group. This compound A is known to undergo a structural change accompanying elimination of the 2-nitrobenzyl group when irradiated with light, changing from the compound A that does not have fluorescence to a fluorescent compound B represented in the following formula (7).

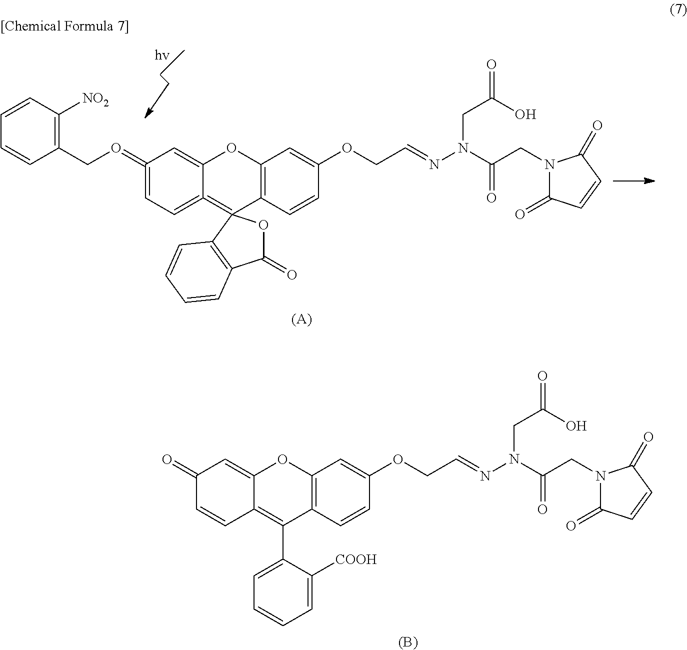

### Example 1

0.006 g of compound A and several drops of cyanoacrylate-based adhesive (Aron Alpha™, Toagosei Co., Ltd.) were dissolved in 3 ml of chloroform to prepare a coating solution containing compound A (to be simply referred to as the coating solution).

Next, a titanium dioxide thin film was formed on a silica glass substrate by sputtering, the coating solution was applied onto the titanium dioxide thin film by spin coating, and the thin film of compound A was used as Sample 1 of Example 1. In Sample 1, the film thickness of the titanium dioxide thin film was 300 nm and the film thickness of the thin film of compound A was 150 nm.

### Example 2

5 g of titanium dioxide fine particles (mean particle diameter: 21 nm, specific surface area: 50 m²/g, trade name: “Super Nanotron DX”, Netin Co., Ltd.) were weighed out and dispersed in 20 ml of pure water to prepare a dispersion.

Next, the coating solution was applied onto a silica glass substrate by spin coating to form a thin film of compound A, the dispersion was applied to the thin film of compound A by spray coating, and a thin film of the titanium dioxide fine particles was used as Sample 2 of Example 2. In Sample 2, the film thickness of the thin film of compound A was 150 nm.

(Comparative Example 1)

The coating solution was applied to a silica glass substrate by spin coating, and the product of forming a thin film of compound A was used as Sample 3 of Comparative Example 1. In Sample 3, the film thickness of the thin film of compound A was 150 nm.

[Light Radiation]

The Samples 1 to 3 prepared in the manner described above were irradiated for 20 seconds with light of a wavelength of 365 nm by contact exposure through a photomask having an L/S (line/space) value of 20 μm/20

Luminous intensity at this time was 45 mW/cm² and exposure was 900 mJ/cm². With respect to Sample 2 of Example 2, the thin film was washed with water after exposure to remove titanium dioxide fine particles on the surface.

[Fluorometry]

Each of the samples following exposure were observed with a fluorescent microscope, and profiles of fluorescence intensity were determined from fluorescent micrographs acquired using a high sensitivity camera. Profiles of fluorescence intensity were obtained by measuring fluorescence intensity at four locations for each sample. The Model 41017 Endow GFP Bandpass Emission Filter (Chroma Technology Corp.) was used for the filter set of the fluorescent microscope. This filter set makes it possible to observe fluorescence in the vicinity of 520 nm emitted from a sample by irradiating the sample with excitation light in the vicinity of 470 nm.

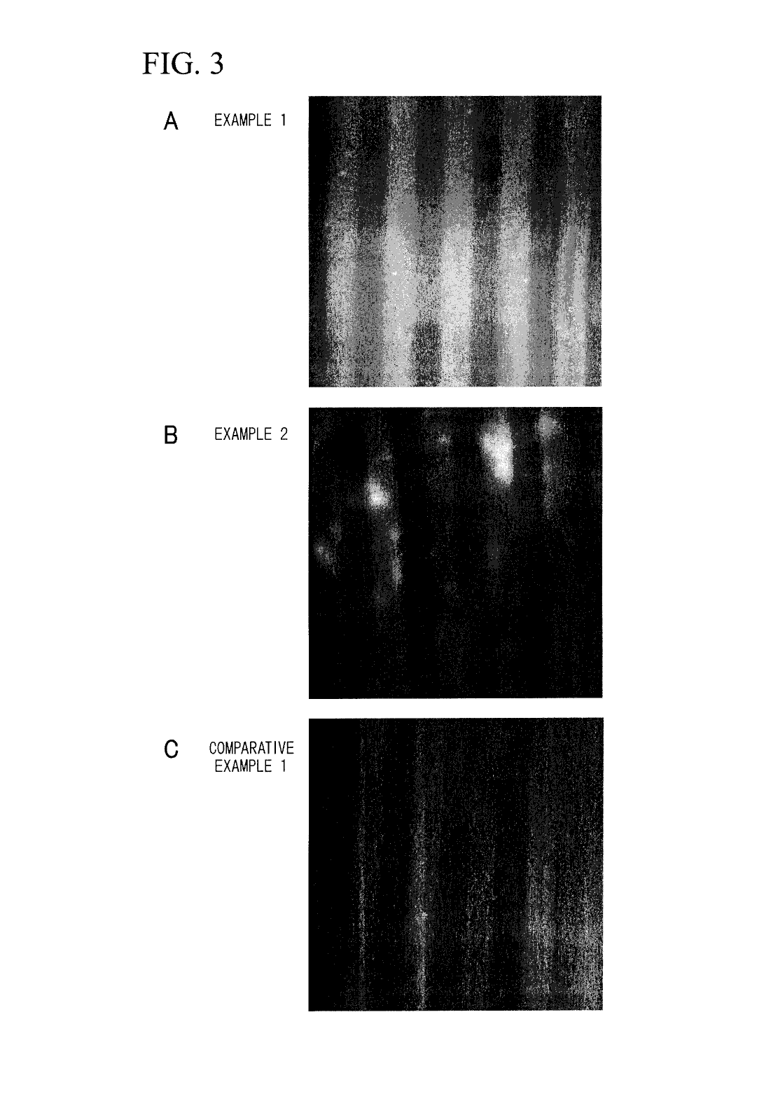

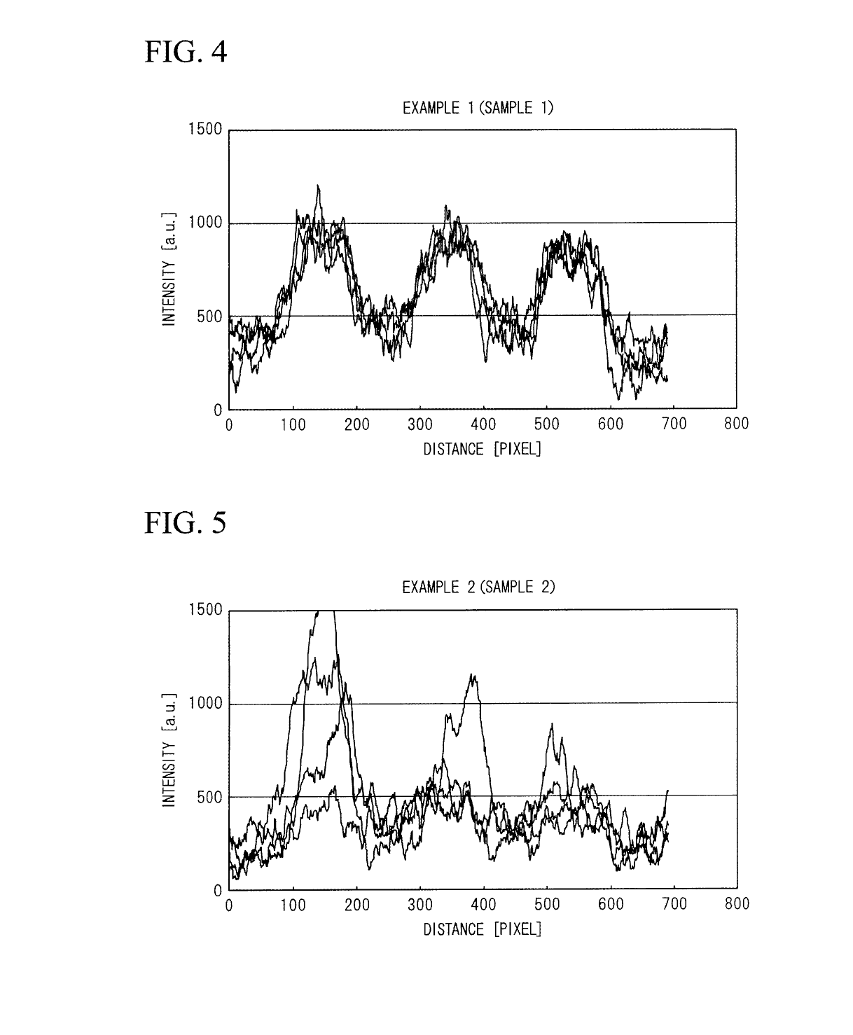

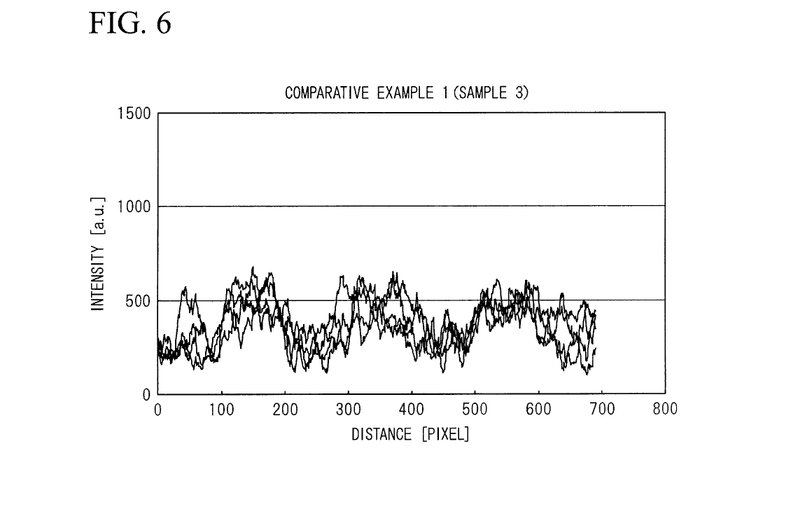

FIGS. 3 to 6 show results obtained for the aforementioned examples and comparative example. FIG. 3 consists of photographs showing fluorescent micrographs for Samples 1 to 3, with FIG. 3A representing Sample 1, FIG. 3B representing Sample 2 and FIG. 3C representing Sample 3. FIGS. 4 to 6 indicate fluorescence intensity profiles obtained in a direction roughly perpendicular to the striped L/S patterns formed in Samples 1 to 3, with FIG. 4 indicating the profile for Sample 1, FIG. 5 indicating the profile for Sample 2, and FIG. 6 indicating the profile for Sample 3.

As has been previously described, compound A is known to change from non-fluorescing to fluorescing when irradiated with light. Thus, the magnitude of fluorescence intensity following exposure corresponds to the magnitude of the elimination reaction rate of the 2-nitrobenzyl group serving as the photoreactive protecting group. Namely, in the L/S patterns shown in FIG. 3, the portion having the greater fluorescence intensity corresponds to the portion that has been irradiated with light.

Here, when fluorescence intensity is compared between Sample 1 (FIGS. 3A and 4) and Sample 3 (FIGS. 3C and 6), the fluorescence intensity of Sample 1 containing titanium dioxide is greater than the fluorescence intensity of Sample 3 for all four measurement points, thereby confirming that the elimination reaction of the 2-nitrobenzyl group is accelerated by the presence of the titanium dioxide serving as a photocatalyst.

In addition, although demonstrating some variation depending on the measurement point, the fluorescence intensity of Sample 2 (FIGS. 3B and 5) was indicated to exceed that of Sample 1 at specific measurement points. This is thought to be the result of the titanium dioxide fine particles in Sample 2 not being evenly dispersed.

Namely, although titanium dioxide fine particles were applied to a thin film of compound A following deposition thereof in Sample 2, even when in this state, acceleration of the protecting group elimination reaction is similar to that of Sample 1. However, since the titanium dioxide fine particles were applied by spray coating in Sample 2, there is unevenness in the amount of titanium dioxide fine particles applied, and the photoreactive protecting group elimination reaction is presumed to have proceeded rapidly particularly within the range the titanium dioxide particles were locally adhered. This is also supported by the bright portions in the fluorescent micrograph of FIG. 3B being unevenly dispersed.

On the basis of the above results, the combined use of a photocatalyst was confirmed to accelerate the elimination reaction of the photoreactive protecting group, thereby confirming the usefulness of the present invention.

### INDUSTRIAL APPLICABILITY

According to the pattern formation method of an aspect of the present invention, since an elimination reaction of a photoreactive protecting group is accelerated by the combined use of a photocatalyst, processing time when forming a circuit pattern and the like can be shortened.

### BRIEF DESCRIPTION OF THE REFERENCE SYMBOLS

1: substrate, 2,4,7,8,9: silane coupling agent, 2A,2B,7A, 7B,7C: thin film, 3,6: photocatalyst, 5: pattern forming material

1. A pattern formation method for forming a desired pattern on surface to be treated of a target, comprising:
arranging a silane coupling agent represented by general formula (1):
[Chemical Formula 1]
R¹—R²—SiX¹X²X³ (1)
(wherein, R¹ represents a photoreactive protecting group that is eliminated by irradiating with light, R² represents an organic group that generates a functional group that has lyophilicity-lyophobicity differing from that of R¹ as a result of elimination of R¹, X¹ represents an alkoxy group or halogen atom, X² and X³ represent a substituent selected from a hydrogen atom, alkyl group, alkenyl group, alkoxy group and halogen atom, and X¹, X² and X³ may be the same or different), on the surface to be treated and having a photocatalyst present for the silane coupling agent on the surface to be treated; and,
irradiating the silane coupling agent and the photocatalyst with light containing light having absorption wavelengths of the silane coupling agent and the photocatalyst.

2. The pattern formation method according to claim 1, wherein R¹ in general formula (1) has a fluorine-substituted alkyl group.

3. The pattern formation method according to claim 1, further comprising:
modifying a functional group generated on R² in general formula (1) by eliminating R¹ in general formula (1) with a substituent having lyophilicity-lyophobicity differing from that of R¹ after the step for irradiating with light.

4. The pattern formation method according to claim 1, wherein said having a photocatalyst present for the silane coupling agent comprises:
arranging the silane coupling agent on the target, and
applying a dispersion of the photocatalyst onto the silane coupling agent.

5. The pattern formation method according to claim 1, wherein said having a photocatalyst present for the silane coupling agent comprises:
forming a photocatalyst layer having the photocatalyst as a forming material thereof on the target, and
arranging the silane coupling agent on the photocatalyst layer.

6. The pattern formation method according to claim 1, wherein the silane coupling agent is arranged by applying the silane coupling agent.

7. The pattern formation method according to claim 1, wherein the absorption wavelengths of the silane coupling agent and the photocatalyst are in the same wavelength band.

8. The pattern formation method according to claim 1, further comprising:
applying a solution or dispersion of a pattern forming material to a region where lyophilicity is demonstrated to a relatively greater degree in the pattern after the step for irradiating with light.

9. The pattern formation method according to claim 1, wherein a region in the pattern on which the light is irradiated is made to be a region of relatively higher lyophobicity.

10. The pattern formation method according to claim 1, wherein a region in the pattern on which the light is irradiated is made to be a region of relatively higher lyophilicity.

11. The pattern formation method according to claim 8, wherein the pattern forming material is an electrically conductive material.
